(19) United States
(12) Patent Application Publication
(10) Pub. No.: US 2026/0326476 A1
(43) Pub. Date: Oct. 22, 2026

(54) HANDWRITING DETECTING PEN

(71) Applicant: Nuwa Spatial B.V., Groningen (NL)

(72) Inventors: Marc Tuinier, Groningen (NL); Vishal Raveendranathan, Groningen (NL); Breno Cunha Queiroz, Groningen (NL); Riordan Benjamin Boyd Maduro, Vries (NL); Franciszek Pawel Szewczyk, Vienna (AT); Cas Kempers, Zwolle (NL); Shubham Koyal, Groningen (NL)

(73) Assignee: Nuwa Spatial B.V., Groningen (NL)

(21) Appl. No.: 19/116,742

(22) PCT Filed: Sep. 28, 2023
(86) PCT No.: PCT/NL2023/050507

§ 371 Date: Mar. 28, 2025

(30) Foreign Application Priority Data
Sep. 29, 2022 (NL) 2033190
Mar. 3, 2023 (NL) 2034260

(51) Int. Cl. B43K 29/08; B43K 29/10; G01D 5/12; G06V 10/24; G06V 10/44; G06V 30/14; G06V 30/142; G06V 30/146; G06V 30/18; G06V 30/22; H04N 23/74; H04N 23/90

(52) U.S. Cl. CPC B43K 29/08; B43K 29/10; G01D 5/12; G06V 10/24; G06V 10/44; G06V 30/142; G06V 30/1437; G06V 30/1463; G06V 30/1801; G06V 30/22; H04N 23/74; H04N 23/90

(57) ABSTRACT

A handwriting detecting pen, including a writing device (1) for performing a writing operation on a writing surface (S) of a substrate (P), wherein the writing device (1) has a camera system (5) for recording at least part of the writing surface (S) during operation, characterized in that a field of view of the camera system is at least 90 degrees, preferably at least 110 degrees, for example about 125 degrees. The writing device can record markings (e.g. writing) made by the device on a substrate within a relatively large range of orientations of the writing device with respect to the writing surface. The optically recorded markings can e.g. be processed by the writing device (in particular by a respective image processor thereof) to generate output data representing, containing or being associated with the recorded markings.

The invention relates to a handwriting detecting pen.

Various examples of handwriting or symbols/markings detecting pens are known from the prior art. For example, EP0856810 discloses a handwriting detecting and storing apparatus that comprises a lens having a cone shape at a front-most position of a lens system which introduces handwriting image to image pick up means such as a charge-coupled device or the like. The known pen includes a pen shaft provided at a center of the lens having a cone shape, and wherein an optical axis of the lens system, an optical axis of the lens having a cone shape and a central axis of the pen shaft are coincident with one another, so that a writing operation is performed using a writing device, handwriting image is picked-up and picked up handwriting information is stored therein. During operation, an image within the picked up field of view is stored as an image that includes deformed writing within a region neighboring a point just below the leading edge of the pen stylus when no correction processing is applied. To correct for the deformation, the deformed region of the image is subjected to image processing and is corrected by a correction means. By applying the correction processing, accurate handwriting with no deformations included in a region neighboring a shadow region is reproduced.

U.S. Pat. No. 5,294,792 discloses a self-contained pen computer that is capable of acquiring data representative of written strokes of the stylus of the pen and then recognizing the symbols associated with these pen strokes, or compacting these strokes. These recognized symbols or compacted strokes are stored in a memory contained in the pen and are transmitted via a transmitter contained in the pen to a host computer. The pen utilizes a stylus movement detector and a stylus up/down detector, digitized signals of which are fed to a hand print recognition chip. According to an embodiment, capacitively coupled device (CCD) scanning elements are employed to detect the symbols on the paper written by the stylus of the pen. For this embodiment, a ring of CCDs are placed near the stylus end of the pen. A suitable lens system (that is blended into the exterior of the pen) provides the ring of CCDs with a very narrow field of view immediately adjacent the pen stylus. In this manner, as the stylus makes a mark on a writing surface that mark is detected by one or more CCDs and converted by a digitizer into a peak voltage localized to a particular position relative to an arbitrarily assigned “up” (or zero degrees) position. An infrared (IR) light emitting diode (LED) mounted in or on the exterior of the pen near the writing end may provide illumination for the CCDs if the incident light level is too low for the CCDs to operate satisfactorily. As the CCD ring's pulsed output is provided to the digitizer, it represents a line detection and relative position, as well as a relative length based on the number of occurrences (which depends upon the CCD clocking rate) at that same relative position. In this manner, lines, their crossings and other suitable types of input data may be supplied to the recognition chip for analysis and recognition, or compaction. The CCD embodiment of the pen computer of the present invention may be particularly useful for recording information and/or authorizations for particular types of forms. If the data is stored along with a time stamp, i.e. a time and date of the storing, it is possible to correlate receipt of information and/or authorizations. For example, a specific form could have a barcode at its top that could be scanned by the CCDs and stored to identify what information was written on that form and when it was authorized by a signature. This would provide a hard copy form, as well as an electronic audit trail with the time stamped information and/or authorization for that form.

The publication ‘Smart pen and related method for detecting ink applied by a smart pen onto a writing surface’, Technical Disclosure Commons, Defensive Publications Series Oct. 6, 2017 discloses a smart pen, equipped to differentiate content created on the writing surface using the pen from other content contained on the writing surface. The smart pen is provided with a specialized type of ink that is configured to reflect light when illuminated with a given light source, thereby allowing the ink to be easily identified or detected within images captured via a camera of the smart pen.

US2016/0018910 discloses pen shaped hand-held instrument for processing a substrate, comprising: at least one pen tip; a shaft; at least one optical sensor; and at least three acceleration sensors, wherein the pen tip is in contact with the substrate in an operating position of the hand held hand held instrument, wherein the at least one optical sensor is arranged proximal to the pen tip at an end of the hand held instrument that is oriented towards the substrate. The optical sensor has an image angle of at least 90°, wherein at least an identification portion which includes a portion of the substrate and at least a lateral edge of the substrate and at least a portion of a surrounding area of the substrate which is directly adjacent to all edges of the substrate is detectable from an identification position in which the pen tip has a distance from the substrate, wherein the at least three acceleration sensors are respectively arranged perpendicular to each other and continuously detect an acceleration of at least a portion of the hand held instrument in a three dimensional space. The pen is used to detect at least a coarse pattern from an identification position in which the pen tip has a distance from the substrate. In this way, a unique association of the hand held instrument with a substrate and/or a detection of a change of the substrate can be facilitated in that a sufficiently large portion of the substrate is optically detected, wherein a “coarse pattern recognition” is performed by the at least one optical sensor. This means that it is not required that the portion of the substrate is detected with full resolution; the detected image may rather be slightly unfocused. Thus, it is sufficient when a coarse pattern is detected.

Disadvantages of such known systems include relative user-unfriendliness, wherein the systems can require special paper (having specific markings) and/or special ink for operation. In addition, known systems can require the user to hold the pen at a specific orientation with respect to the paper in order to function properly.

The present invention aims to provide an improved handwriting detecting pen, in particular a pen that is user friendly and reliable. To that aim, there is provided a pen as defined in the features of claim 1.

According to an aspect of the invention there is provided a handwriting detecting pen, including a writing device for performing a writing operation on a writing surface of a substrate, wherein the writing device has a camera system for recording at least part of the writing surface during operation, wherein a field of view of the camera system is at least 90 degrees, preferably at least 110 degrees, for example about 125 degrees.

It has been found that in this way, the writing device can record markings (e.g. writing) made by the device on a substrate within a relatively large range of orientations of the writing device with respect to the writing surface. The optically recorded markings can e.g. be processed by the writing device (in particular by a respective image processor thereof) to generate output data representing, containing or being associated with the recorded markings.

Herein, the field of view (FOV) of the camera system can be defined as the field of view provided by the camera system to the pen. It is preferred that a central axis of the FOV coincides with a central axis (center line) of the pen, extending e.g. centrally through an ink dispensing tip of the pen. The pen's FOV (as provided by the camera system) is preferably a substantially conical field of view (i.e. the FOV is bounded by a virtual cone), a top angle of the cone being at least 90 degrees.

The pen as such can be configured in various ways, and it will be appreciated that the writing device can have a distal writing tip and a respective ink reservoir for feeding ink to the writing tip. The pen can include e.g. an elongated pen housing for containing the ink reservoir (which may be a rechargeable and/or replaceable ink reservoir), the housing being handheld by a writer/user/marker during pen operation. The camera system can e.g. be located at or near a distal end of the pen housing, i.e. near a respective writing tip. Ink that is used by the pen is preferably normal ink, i.e. ink that is directly readably by a user under normal lighting conditions.

According to a highly preferred embodiment, the camera system has three camera units, having mutually different viewing angles, preferably symmetrically arranged with respect to a centerline of a housing of the writing device, in particular for recording respective sets of images that encompass the entire field of view of the camera system.

Thus, a large field of view can be achieved (wherein field of views of the three camera units combine to provide the overall FOV of the camera system) and reliable recording of pen written markings. It is preferred that the three camera units are arranged such that their individual FOVs partly overlap. It has been found that in case only three camera units as used, optimum results in a compact pen configuration can be obtained. Each of the cameras can e.g. be a CCD (charged-coupled device) camera. An optical axis of each of the three cameras preferably includes an angle in the range of 5 -45 degrees (for example an angle in the range of 20-30 degrees) with respect to a center line of the pen. Preferably, the optical axes of the three camera units mutually diverge with respect to each other. Herein, an optical axis of a camera unit is defined as the optical axis of a respective field of view provided by the respective unit (e.g. the optical axis extends through a respective outer light transmitting aperture of the pen).

According to a preferred embodiment, the writing device includes a processor configured to process images received from the camera system to determine handwriting data concerning handwriting on a recorded writing surface section, the processor preferably being configured to evaluate and/or store detected handwriting data. Good results are achieved when the processor is configured to convert bitmap images into vector space data, preferably using a suitable algorithm (for example an edge detection algorithm), and process the resulting vector space data to determine the handwriting data. In this way, efficient and reliable image processing can be achieved by the pen itself. Regarding the term ‘bitmap’, it is noted that a bitmap image is an image made of pixels (https://en.wikipedia.org/wiki/Bitmap).

Besides, it has been found that efficient data processing can be achieved in case the processor is configured to determine an orientation of the writing device with respect to the writing surface, wherein the processor is preferably configured to utilize a determined orientation of the writing device with respect to the writing surface in transforming a coordinate system of determined handwriting data to a coordinate system of the writing surface.

According to a preferred embodiment, the pen includes at least one inertial measuring unit (IMU), for example including a gyroscope and/or accelerometer, wherein the processor is configured to determine the orientation of the writing device with respect to the writing surface using sensor results of the at least one inertial measuring unit. In that case, it has been found that improved, accurate pen orientation can be determine in case the pen including a first inertial measuring unit at or near a proximal end of the writing device and a second inertial measuring unit at or near a distal end of the writing device (wherein measurements of both IMUs can be used by the processor for determining the orientation of the writing device with respect to the substrate/writing surface).

Moreover, according to a preferred embodiment the processor is configured to process the images received from the camera system to detect at least one edge of the substrate's writing surface (i.e. the edge being an edge of the substrate as such). In addition or alternatively, one or more other algorithms can be applied by the processer to process the images, for example a skeletonization algorithm (see e.g. https://en.wikipedia.org/wiki/Topological skeleton, providing different algorithms for computing skeletons for shapes in digital images).

By carrying out edge detection, the processor can better define a pen orientation with respect to the writing surface (i.e. substrate). In that case, the processor can be configured to convert bitmap images into a vector space data, using an edge detection algorithm, and process the resulting vector space data to determine edge data concerning the at least one edge of the substrate's writing surface. As an example, 2D coordinates X_{eb}, Y_{eb} of a detected edge of the substrate (e. g X_{eb}=100, Y_{eb}=200) can be associated or linked to a 2D central reference coordinate Xₑᵥ, Yₑᵥ (e.g. Xₑᵥ=0, Yₑᵥ=0) of the vector space.

Preferably, the pen includes at least one light source, for example a light emitting diode (LED), for illuminating at least part of the writing surface with light, for example infrared light and/or visible light. In this way, improved pen operation can be achieved under low-light conditions, wherein the light source can provide (additional) surface illumination for detecting any pen written markings.

The writing device preferably includes a (distal) cap having at least one light transmission section, for example an opening or transparent wall section, for transmitting incoming light to the camera system. In case of three camera units, the cap can e.g. include three respective light transmission sections. Moreover, in case of an integrated light source, it is preferred that the cap includes additional one or more light emitting sections for emitting illumination light of the light source(s). Moreover, then, it is preferred that the pen includes a light guide structure for guiding light from the or each light source to a respective light emitting section of the cap. In this way a compact configuration can be achieved that provides optimized writing surface illumination. Besides, light receiving sections of the cap can be separate from light emission sections, and the optional lightguide structure can be configured for guiding source light along one or more internal paths that are separate from optical paths concerning incoming light that is to be detected by the camera system, thereby avoiding direct interference of source light with camera system operation. Also, it is preferred that the pen includes a light diffuser (which can e.g. be part of or integrated with said cap) for diffusing light emanating from the light source. As is mentioned before, the light can be e.g. infrared light, and/or visible light (e.g. light having a wavelength in the 400-700 nm range).

Further extra advantageous embodiments of the invention are provided in the dependent claims.

A non-limiting example of the invention is depicted in the drawings. Therein shows:

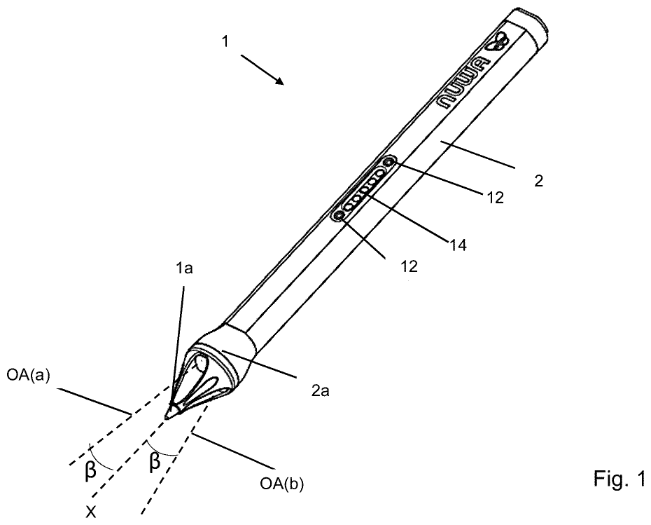

FIG. 1 an isometric view of an embodiment of the invention;

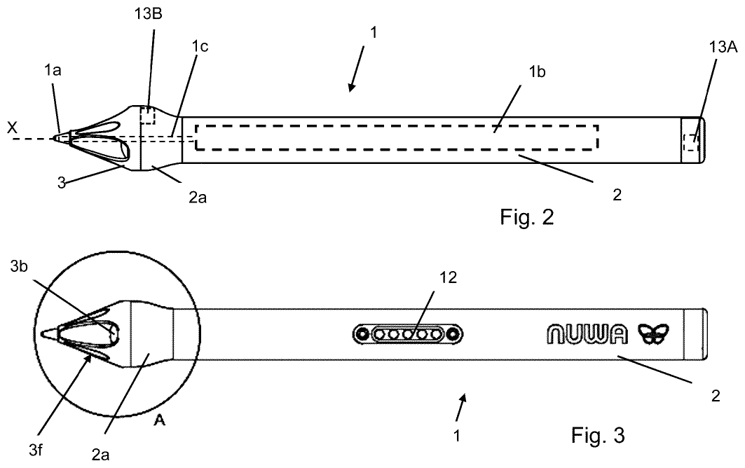

FIG. 2 a top view of the embodiment;

FIG. 3 a side view of the embodiment;

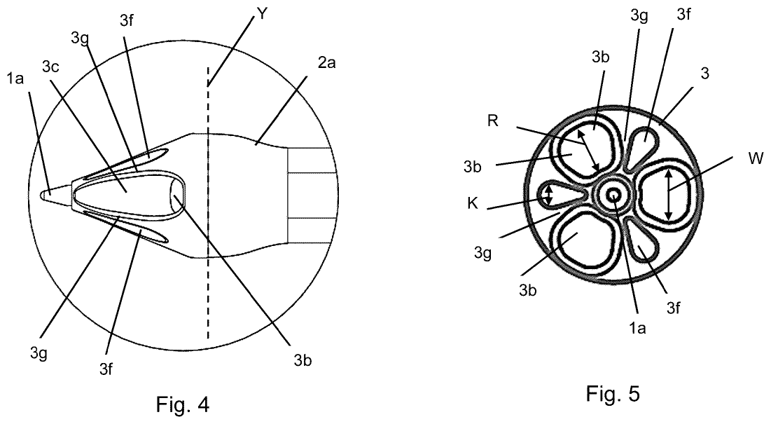

FIG. 4 a detail A of FIG. 3;

FIG. 5 a front view of the embodiment;

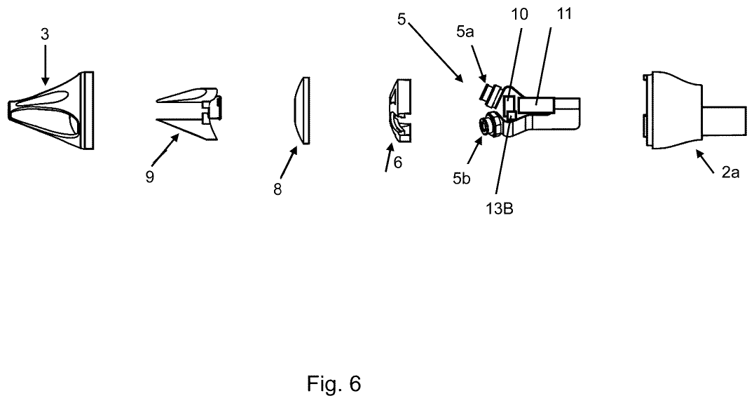

FIG. 6 an exploded view of part of the embodiment;

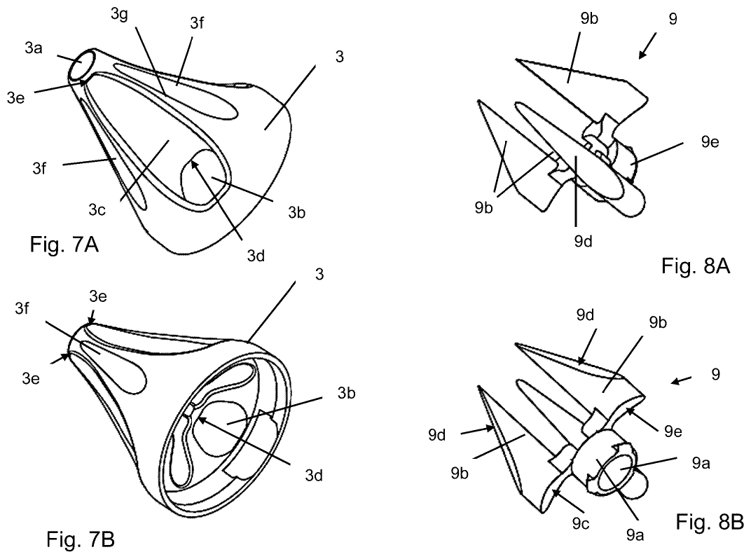

FIGS. 7A and 7B an isometric front view and isometric back view, respectively, of a tip section of the embodiment;

FIGS. 8A and 8B an isometric front view and isometric back view, respectively, of a light guide section of the embodiment;

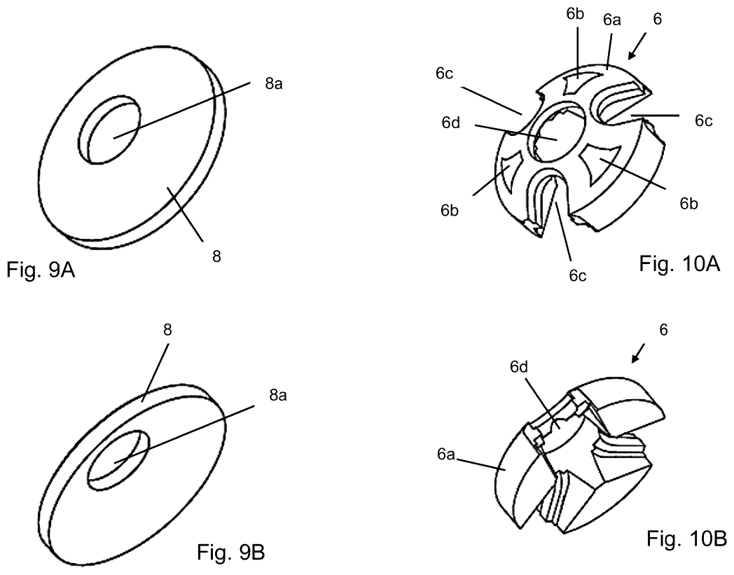

FIGS. 9A and 9B an isometric front view and isometric back view, respectively, of an interior cover of the embodiment;

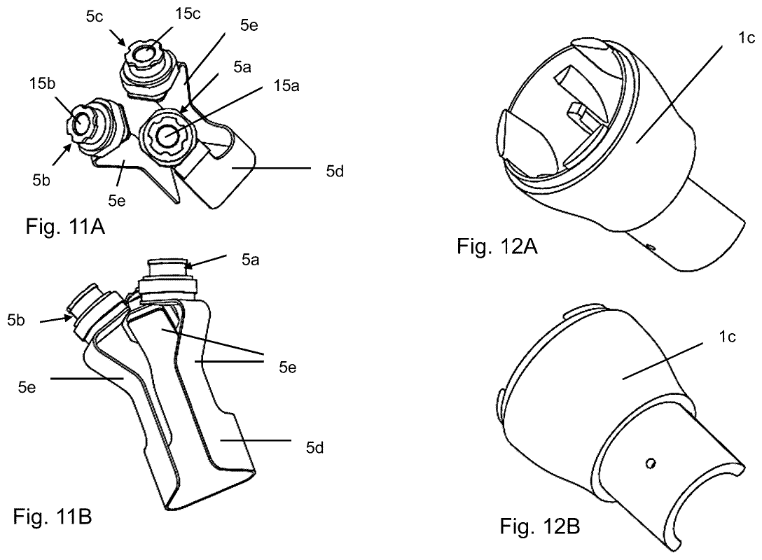

FIGS. 10A and 10B an isometric front view and isometric back, respectively, view of an interior positioning section of the embodiment;

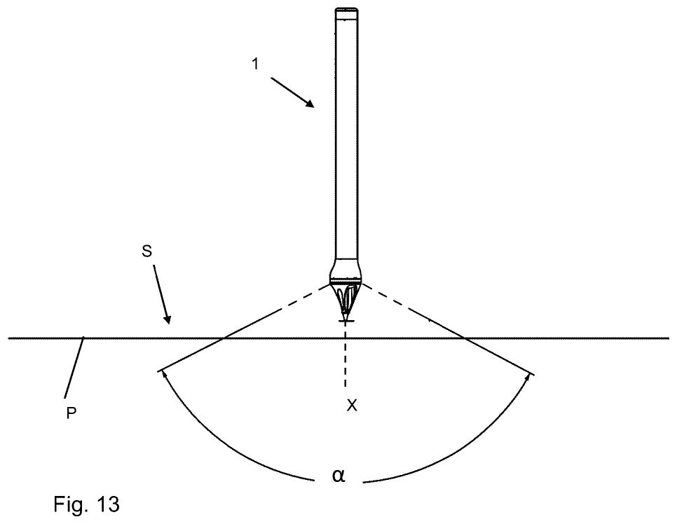

FIGS. 11A and 11B an isometric front view and isometric back view, respectively, of a camera section of the embodiment;

FIGS. 12A and 12B an isometric front view and isometric back view, respectively, of a housing section of the embodiment;

FIG. 13 a side view of the embodiment during operation, at a first pen orientation;

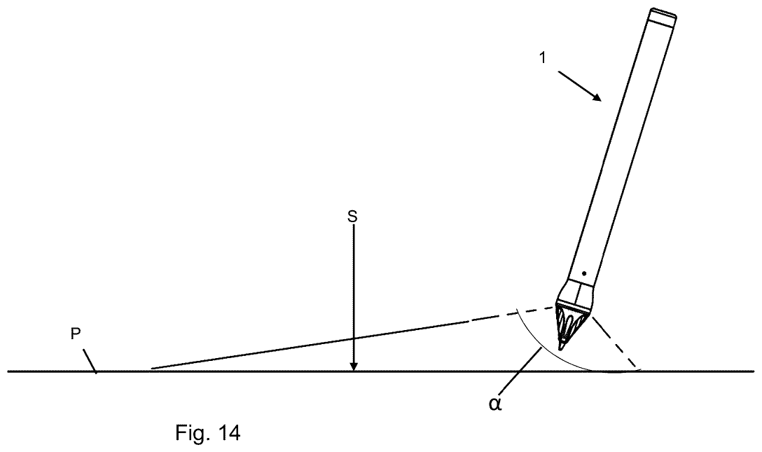

FIG. 14 a side view of the embodiment during operation, at a second pen orientation; and

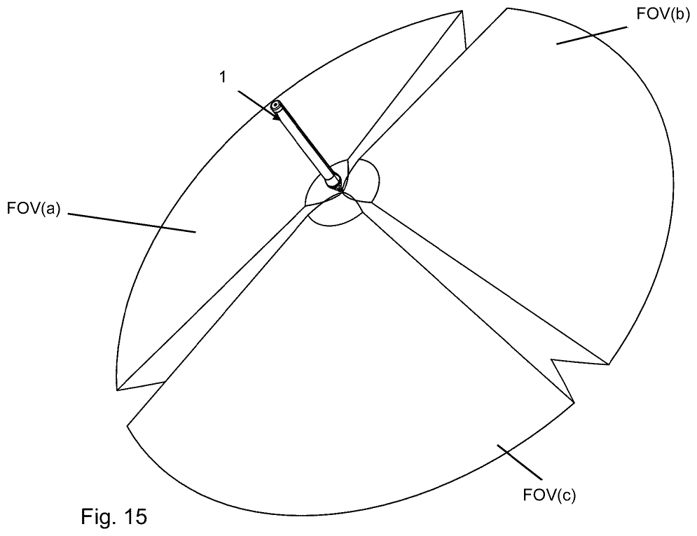

FIG. 15 an isometric back view of the embodiment, indicating a field of view of the camera system.

Similar or corresponding features are denoted by similar or corresponding reference signs in this application.

The drawings show a non-limiting example of a handwriting detecting pen. The pen includes a writing device 1 for performing a writing operation on a writing surface S of a substrate P (see FIGS. 13, 14). The writing device 1 has a distal writing tip 1a and a respective ink reservoir 1b (schematically indicated in FIG. 2), containing ink, for feeding ink to the writing tip 1a (e.g. via an in feeding channel 1c there-between). The pen 1 can include an elongated housing, containing the ink reservoir 1b. Further, the writing device 1 has a camera system 5 for recording at least part of the writing surface S during operation. For example, a housing 2 of the pen 1 can be provided with a distal head section 2a containing the camera system 5 and other components (e.g. an optional light source). FIGS. 6-12 shows various components of the camera system 5 in more detail.

The total field of view of the camera system is at least 90 degrees, preferably at least 110 degrees for example about 125 degrees. The respective FOV angle is indicated by angle a in FIGS. 13, 14, as well by area's FOV(a), FOV(b) and FOV(c) in FIG. 15 (which concern field of views associated with the individual camera units 5a, 5b, 5c of the exemplary camera system 5). The overall FOV of the camera system 5 is preferably symmetrical with respect to a center line X of the pen (the center line extending centrally through the distal writing tip 1a).

In particular, the camera system 5 can be arranged for recording images encompassing the pen's total FOV. Due to the large FOV, relatively large sections of the writing surface can be detected, independently of pen orientation (e.g. a writing angle with respect to the ink receiving surface S as well as a pen's rotational position with respect to the pen's central axis X) with respect to the surface S. Moreover, as will be explained below, the large FOV makes it possible to detect an edge or corner of the respective substrate (e.g. paper) P providing the writing surface, for example in case the substrate has a regular A 4 size (i.e. 210×297 mm).

Good results are achieved in case the camera system has (only) three camera units 5a, 5b, 5c, having mutually different viewing angles. Each of the camera units 5a, 5b, 5c can include a sensor, e.g. a CCD sensor, for digitally recording respective images. It is preferred that each of the camera units 5a, 5b, 5c is configured to generate bitmap images. Also, e.g., each camera unit 5a, 5b, 5c can include projection optics, e.g. one or more optical elements or lenses, for projecting incoming light onto the sensor. FIG. 11a shows example of camera lenses 15a, 15b, 15c of the respective camera units. An optical axis OA of each of the three camera units 5a, 5b, 5c can enclose an angle β (preferable the same angle β), with a center line X of the pen (the angle β being measured in a plane that includes the respective optical axis OA as well as the center line X), for example an angle in the range of 5 -45 degrees (for example a range of 20-30 degrees). Two of the three optical axes of respective camera units are indicated by dashed lines OA(a) and OA(b) in FIG. 1.

Also, preferably, the optical axes of the three camera units mutually diverge with respect to each other. The three camera units 5a, 5b, 5c (and their corresponding optical axes) are preferably symmetrically arranged with respect to the center line X of the housing 2 of the writing device 1, in particular for recording respective sets of images that encompass the entire field of view FOV of the camera system 5. To that aim, e.g., the three camera units 5a, 5b, 5c can be equidistantly symmetrically arranged around the pen's center line X (see the drawings), for example having respective camera lenses 15a, 15b, 15c (if any) being tilted with respect to the pen's center line X to provide respective diverging field of views (i.e. mutually diverging optical axes OA).

The writing device 1 can e.g. include a support structure 5d for supporting and positioning the camera units 5a in a head section 1c of the pen. The camera support structure 5d can include e.g. a sleeve having three L-shaped arms 5e for holding the camera units 5a at respective positions. The sleeve 5d and arms 5e can e.g. surround a space that can receive other pen components after assembly, e.g. a processor 10 and/or power source 11 (see FIG. 6) and/or IMU, as well part of an ink reservoir 1b and/or ink feeding channel 1c.

Further, the writing device 1 can include a support element 6, configured for supporting (and e.g. surrounding) the camera units 5a after assembly. The support element 6 can e.g. be located near the camera system, within a head section 2a of the pen. The support element 6 can include e.g. apertures 6c (e.g. U-shaped openings/apertures) for receiving the camera units 5a of the camera system, so that a compact assembly can be achieved. Also, the support element 6 can include a central opening 6d for receiving an ink feeding channel 1c of the pen, and e.g. for receiving one or more optional light guides such as optical fibers (not shown) for guiding light (e.g. infrared light and/or visible light) from one or more light sources towards a cap 3.

The writing device 1 includes a processor 10 configured to process images received from the camera system 5 to determine handwriting data concerning handwriting on a recorded writing surface section. The processor 10 is schematically indicated in FIG. 6. The processor 10 can be communicatively connected to the camera units 5a, 5b, 5c for receiving digitally registered images therefrom. Optimally, the processor 10 and camera system 5 can be integrated with each other and/or e.g. be provided on a single PCB (printed circuit board). The skilled person will appreciate that the processor 10 can be provided by suitable hardware, executing processor software for carrying out processor functionality. The processor can e.g. be or include a digital microcontroller, a digital signal processor, and/or the-like. It is preferred that the processor has a digital memory for storing the images and e.g. for storing processed images and e.g. other processing results. Also, according to an embodiment, the processor can include or be provided with communication means, for wirelessly communicating with a remote device (e.g. a smartphone, tablet or computer), the communication means e.g. being configured to use a standard communication protocol (e.g. WIFI, Bluetooth™ or the-like).

Further, the writing device 1 can include a power source 11, e.g. a (rechargeable) battery, for electrically powering other components, such as the camera system and the processor 10. Besides, the writing device 1 can include a charging terminal 14 for charging the power source 11 using external power, in case a rechargeable battery is implemented.

Also, the writing device 1 can include a user interface 12 (see FIG. 1), for example display and/or light signaling units (e.g. light emitting diodes) and/or or a haptic feedback unit (e.g. one or more linear resonant actuators) for informing an operator of writing device operation (e.g. battery status). For example, the writing device 1 can include a user operable element, e.g. a switch or button, for controlling the device, such as for activating and/or deactivating the camera system and/or processor. According to an embodiment, the pen tip 1a can be configured to provide the user operable element, wherein the tip 1a e.g. includes a (pressure) sensor that is configured to detect placement or pressure on the writing surface, wherein he tip sensor can be communicatively connected to the processor 10 for providing a sensor signal thereto (in which case the processor 10 can e.g. initiate image processing in case the tip sensor signal indicates pen placement, and wherein the processor 10 can e.g. halt image processing in case the tip sensor signal indicates that the tip has not contacted a writing surface anymore for a certain amount of time).

The processor 10 is preferably configured to evaluate and/or store detected handwriting data. As will be explained below in more detail, the processor 10 is preferably configured to convert bitmap images (received from the camera units 5a, 5b, 5c during operation) into a vector space data, preferably using an edge detection algorithm, and process the resulting vector space data to determine the handwriting data. In this way, efficient and reliable image processing can be achieved by the pen.

Also, it is preferred that the processor 10 is configured to determine an orientation of the writing device 1 with respect to the writing surface (during use of the pen). The processor 10 is preferably configured to utilize a resulting determined-orientation of the writing device 1 with respect to the writing surface S in transforming a coordinate system of determined handwriting data to a coordinate system of the writing surface S. Thus, enhanced processing of images received from the camera system 5 can be achieved.

In order to determine writing device orientation, the pen can include at least one inertial measuring unit IMU 13, for example including a gyroscope and/or accelerometer, wherein the processor 10 is configured to determine the orientation of the writing device with respect to the writing surface using sensor results of the at least one inertial measuring unit 13. Optimum results can be achieved in case the pen includes a first inertial measuring unit 13a at or near a proximal end of the writing device 1 and a second inertial measuring unit 13b at or near a distal end of the writing device 1. Optionally, the second IMU 13b can be located at or near the camera system 5. The two IMUs 13a, 13b can e.g. be spaced-apart over a distance of at least 5 cm.

According to a preferred embodiment, the processor 10 is (also) configured to process the images received from the camera system 5 to detect at least one edge of the substrate's writing surface S. In that case, the processor 10 can be configured to convert the afore-mentioned bitmap images into a vector space data, preferably using an edge detection algorithm, and process the resulting vector space data to determine edge data concerning the at least one edge of the substrate's writing surface S. For example, the processor 10 can be configured to determine an orientation and/or a position of the writing device 1 with respect to the writing surface using the determined edge data.

The device 1 preferably includes a distal cap 3, e.g. having conical external cap surface. The cap 3 is shown in more detail in FIGS. 4, 5, 7A, 7B. The cap 3 has a central aperture/orifice 3a for receiving the writing tip 1a.

Further, the cap 3 can include three light transmission sections 3b, for example optically transparent wall sections or openings 3b, for transmitting incoming light to the three camera units of the camera system 5 (each transmission section 3b being associated with one of the camera units 5a, 5b, 5c). In case the light transmission sections are wall sections, each of those light transmitting wall sections 3b is preferably made of a material that does not diffuse incoming light, e.g. transparent glass or transparent plastic. Each of the light transmission sections 3b can e.g. extend normally with respect to a respective camera unit's optical axis OA (and e.g. be tilted with respect to a plane Y that is normal to the pen's center line X).

Also, the cap 3 can include radially inwardly extending wall sections 3c (i.e. inwardly with respect to a cap's conical outer surface) providing three light entry ports/apertures leading towards the three transmission sections 3b. The radially inwardly extending wall sections 3c of the cap 3 can e.g. extend substantially in parallel with each other and with the center line X of the pen, and can be e.g. be slightly curved or straight wall sections, wherein proximal edges 3d of these wall sections 3c can be located at radially inward edges of the respective light transmission sections 3b. Similarly, distal edges 3e of the radially inward wall sections 3c can be located at or near the central distal aperture 3a of the cap 3. Also, the three light transmission sections 3b of the cap can be symmetrically arranged with respect to the center line X of the writing device 1, in particular equidistantly symmetrically arranged around the pen's center line X.

As follows from FIG. 5, each of the three light transmission sections 3b can be substantially square or rectangular, or trapezium shaped e.g. having rounded corners, when viewed in front view, but that is not required. In particular (see FIG. 5), a radial width R of each of these light transmission sections 3b can be about the same as a circumferential width W of that wall section (the radial width e.g. being in the range the circumferential width plus and minus 20% of that circumferential width), providing a relatively large light entry surface for the respective camera unit.

The pen preferably includes at least one light source (e.g. an infrared light source, and/or a light source for emitting visible light such as light having a wavelength in the range of 400-700 nm), for example including one or more light emitting diodes, for illuminating at least part of the writing surface S with light. For example, each light source can be configured to be automatically activated during operation, by the processor 10 and/or camera system 5, in case of low-light conditions. The light source can e.g. be powered by a pen's power source 11.

A non-limiting example of the light source is depicted in FIGS. 10A, 10B, showing that the support element 6 can have a light source support section 6a having three spaced-apart light emitting devices 6b.

The three light emitting devices 6b can be symmetrically arranged with respect to the center line X of the writing device 1, in particular equidistantly symmetrically arranged around the pen's center line X. The light source support section 6a can include e.g. apertures 6c (e.g. U-shaped openings/apertures) for receiving the camera units 5a of the camera system, so that a compact assembly can be achieved. Also, the support section 6a can include a central opening 6d for receiving an ink feeding channel 1c of the pen.

Alternatively, for example, one or more light sources can be separate from the support element 6, for example located proximally with respect to the support element 6, in which case emitted light can be transmitted from the or each light source to the cap 3 via one or more optical fibers (not shown) extending through the central aperture 6d of the support element 6.

Also, the pen preferably includes an light guide structure 9 for guiding light from the (or each) light source 6 to light emitting sections 3f (e.g. openings) of a distal cap 3 of the pen.

The present cap 3 has three separate light emitting section 3f, for emitting illumination light of the light source 6 (however, more or less than three such light emitting sections can be applied). Preferably, separate light emitting sections 3f and the light receiving sections 3b of the cap are arranged such that emitted light (emitted by the light guide structure 9 via the light emitting sections 3f) can not directly reach the light receiving sections 3b. For example, intermediate light blocking sections 3g of the cap 3 can prevent light transmission from the light emitting sections 3f to the light receiving sections 3b.

Preferably, the device includes an light diffuser for diffusing light emanating from the light source. For example, the light guide structure 9 can be configured to diffuse the light that it emits via the emitting sections 3f of the cap (for example, the light guide structure 9 can include optically translucent material, for diffusing the light that is to be emitted).

Each of the cap's light light emitting sections 3f can e.g. extend in/along a conical plane defining an outer surface of the cap. As follows from FIG. 4, the light emitting sections 3f can be located distally with respect to the light receiving sections 3b of the cap 3. Also, the light emitting sections 3f of the cap can be symmetrically arranged with respect to the center line X of the writing device 1, in particular equidistantly symmetrically arranged around the pen's center line X. As follows from FIG. 5, each of the three light emitting sections 3f can be substantially droplet shaped when viewed in front view but that is not required. Also, a circumferential width K of each of the three light emitting sections 3f can be significantly smaller than the circumferential width W of the light transmission sections 3b, e.g. at least 2x smaller and in particular at least 3x smaller. Also, distal edges of the light emitting wall sections 3f can be located at or near the central distal aperture 3a of the cap 3.

The pen preferably includes an light guide structure 9 for guiding light from the light source 6 to each emitting section 3f of the cap 3. The light guide structure 9 can be arranged within the pen head section and/or cap, and can be positioned between the light source 6 and the light emitting sections of the cap. The light guide structure 9 can include a central aperture 9a for receiving the pen's ink feeding channel 1c. The light guide structure 9 can be configured to transmit light, received from the light source 6, towards (and e.g. through) the cap sections 3f using total internal reflection. According to one embodiment, the light guide structure 9 can be entirely made of transparent material. Alternatively, at least part of the light guide structure 9 can be made of translucent material, for diffusing the light.

In the present exemplary embodiment the light guide structure 9 includes three spaced-apart light guiding teeth 9b, that can be joined or mounted e.g. on a central ring-shaped support part 9e. Each of the teeth 9b can include a proximal light entry surface 9c that is positioned opposite a respective light emitting section 6b of an afore-mentioned light source 6 (or optical fiber output end) after assembly. Also, each of the teeth 9b can include a distal light exit section 9d that is positioned opposite or in (e.g. protrudes through) a respective light emitting section 3f of the cap 3. For example, the three proximal light entry surfaces 9c can extend substantially along the same virtual plane, substantially perpendicular (radially) with respect to the pen's center line X. The distal light exit sections 9d can e.g. extend substantially along a virtual conical plane that extends along an inner surface of the cap 3. It is preferred that the distal light exit sections 9d snuggingly fit in the respective light emitting sections 3f of the cap after assembly. Also, preferably, the three distal light exit sections 9d of the light guide structure 9 have substantially the same shape as the respective light emitting sections 3f of the cap. According to an embodiment, radially inner edges of the light guide structure 9 (e.g. of the three teeth 9b) can extend in parallel. Also, each of the teeth 9b can include a sharp distal tip that can be located near the cap's central aperture 3a.

Optionally, the head and/or cap section of the pen can include additional components, for example an internal optically transparent cover member or circular platelet or lens 8 that can e.g. be provided on top of the camera system 5 and/or light source 6 for protecting and/or positioning of such elements. The internal cover member (e.g. lens) 8 can e.g. have a central opening 8a, e.g. for receiving a said central support part 9e of an optional light guide structure 9 and for allowing passage of said ink feeding channel 1c, and e.g. for passage of one or more optional light guides (e.g. optical fibers) for transmission of light to the cap.

During operation, a user can write markings, e.g. writing or a drawing, onto a writing surface S of a substrate (e.g. paper) P. The camera units 5a, 5b, 5c of the pen record images which are received and processed by the processor 10. Due to the large FOV of the pen, and the respective configuration of the camera system, optimum recording of the writing surface can be achieved, wherein the pen can be dimensioned relatively compact providing a user-friendly writing experience. Also, the pen can be orientated at a large number of angles with respect to the writing surface, within a range of 0-360 degrees of a rotational position around the pen's center axis X.

During operation, the integrated processor 10 can process the bitmap images received from the camera system 5 to determine handwriting data concerning handwriting on a recorded writing surface section. The processor 10 can evaluate and/or store detected handwriting data, and can convert bitmap images into vector space data, using an edge detection algorithm, and process the resulting vector space data to determine the handwriting data. A non-limiting example of the processing is explained below in more detail. Also, the processor 10 can determine the instantaneous orientation of the writing device 1 with respect to the writing surface S, wherein the processor can utilize the determined orientation of the writing device 1 with respect to the surface S in transforming the coordinate system of determined handwriting data to the coordinate system of the writing surface S. The actual orientation of the writing device 1 can e.g. be determined using data received from the two IMUs and/or by detected edge data concerning the writing surface. Preferably, both the determined edge data and IMU data are used in the orientation determination.

Operation of the pen can in particular include conversion of recorded bitmap images to vector space, however, it will be clear that other types of image processing and computer vision can be implemented. An example of a conversion (which can be carried out by the pen's processor 10) is explained in the following.

A first step in converting each recorded image into a vector space, by the processor 10 can include separating handwriting from the substrate and the substrate from the environment (e.g. the substrate, paper, an environment of the substrate, a table, etc.). A result of this step can be a bitmap image wherein each pixel can be marked as either background or as handwriting or as substrate edge. Therein, e.g. white parts of the image (handwriting) can be 1 pixel wide. For example, in one image processing step, the processor 10 can mark pixels as being either background (e.g. substrate) pixels, substrate edge pixels (e.g. for position estimation) or handwriting pixels. Further, to that aim, the image processor 10 can be configured to determine local gradients and local exposure levels in the bitmap image.

The respective image processing, by the processor 10, can include the following steps 1-5 (wherein not all steps are required to provide good end results):
Step 1. A smoothening step, wherein the image is smoothed in order to reduce noise;
Step 2. An exposure adjustment step wherein the image's local and global exposure levels are adjusted in such a way that the contrast between the handwriting, the substrate and the environment is as high as possible;
Step 3. Carrying out an edge detection algorithm (e.g. a canny edge detection algorithm):
3a. Image's local gradients (directional change in pixel intensity) are calculated;
3b. Pixels with gradient values below a low threshold are rejected and marked as background;
3c. Pixels with gradient values above a high threshold are marked as strong edges;
3d. Pixels with gradient values between low and high threshold are marked as strong edges only if they are neighbouring with a strong edge. Otherwise, they are marked as background; and
3e. Outputting the result of the previous steps 3a-3c, the result being a bitmap where each pixel is either marked as background or as a strong edge.
Step 4. A convolution step, wherein convolution is performed by the processor on the image in such a way that pixels are marked as either strokes or background or substrate edge, while ensuring that:
4a. Stroke marked chains of pixels are 1 pixel wide; and
4b. Stroke marked edges lie exactly in between two pixels marked previously as strong edges.
Step 5. Outputting a final result, which is a bitmap, where each pixel is either assigned as background or handwriting or substrate edge. Therein, the handwriting pixels preferably form lines of 1 pixel width.

Next, Vector Space Conversion (VSC) can be initiated by the processor 10, using the results from above steps 1-5. Vector space conversion as such is commonly known (see e.g. https://github.com/LingDong-/skeleton-tracing).

For example, given the bitmap with pixels marked as handwriting (i.e. the output of Step 5), the processor 10 can operate to identify polylines, that is consecutive neighboring handwriting pixels. Herein, a polyline can be defined as consisting of points whose coordinates are defined by its pixel location.

Furthermore, each polyline ends once there are no more neighboring handwriting pixels or a specific point has more than 1

Then, the VSC (carried out by the processor 10) can be as follows (steps A1-A7):
A1. Given as input is the bitmap with pixels marked as either background or handwriting or substrate edge;
A2. If the width and height of the image are both smaller than a small, pre-determined size, go to step A7.
A3. Raster scan the image to find a row or column of pixels with qualities that best match the following:
   a. Has the least amount of pixels on itself;
   b. The 2 submatrices divided by this row or column do not have pixels on their four corners; and
   c. When two or more candidates are found, pick the one that is closer to the center of the image.
A4. Split the image by this column or row into 2 submatrices (either left and right, or top and bottom depending on whether row or column is selected in the previous step A4).
A5. Check if either of the 2 submatrices is empty (i.e. all 0-pixels). For each non-empty submatrix, recursively process it by going to step A2.
A6. Merge the result from the 2 submatrices, and return the combined set of polylines.

For each polyline from one submatrix whose either endpoint coincides with the splitting row or column, the processor 10 can be configured to find another polyline in the other submatrix whose endpoint meets it. If the matrix was split horizontally, then the x-coordinate of the endpoints can differ by exactly 1, and y-coordinate can differ between 0 to about 4 (depending on the steepness of the stroke portrayed), The reverse goes for vertical splitting.
A7. Recursive bottom: Walk around the 4 edges of this small matrix in either clockwise or ant-clockwise order inspecting the border pixels:
   a. Initially set a flag to false, and whenever a pixel is encountered whilst the flag is false, set the flag to true, and push the coordinate of the 1-pixel to a stack;
   b. Whenever a background pixel or substrate edge pixel is encountered whilst the flag is true, pop the last coordinate from the stack, and push the midpoint between it and the current coordinate;
   Then set the flag to false;
   c. After all border pixels are visited, the stack now holds coordinates for all the “outgoing” (or “incoming”) pixels from this small image section. By connecting these coordinates with the center coordinate of the image section, an estimated vectorized representation of the skeleton in this area is formed by these line segments.

Preferably further improve the estimate using the following heuristics:
d. If there are exactly 2 outgoing pixels, it is likely that the area holds a straight line. Then, return a single segment connecting these 2 pixels;
e. If there are 3 or more outgoing pixels, it is likely that the area holds an intersection, or “crossroad”. Then, carry out a convolution on the matrix to find the 3×3 submatrix that contains the most pixels. Set the center of all the segments to the center of the 3×3 submatrix and return; and
f. If there is only 1 outgoing pixel, find and return the endpoint of the polyline.

### Stroke Generation

After the generating of the set of Polylines (a set of point lists), the processor 10 can be configured to group them together into Strokes (letters etc.) and transform them onto the substrate's coordinate system. This can e.g. be achieved by the processor 10 as via the following steps B1-B2:
B1. Performing a Depth-first search on found polylines in order to mark interconnected polylines and create a set of individual Strokes.
B2. Given current orientation (x, y, z) of the camera relative to the substrate (e.g. paper), map pixel coordinates to local substrate (plane) coordinates. Substrate Edge Detection.

The processor 10 can carry out the following Line Detection steps: D1-D3:
D1. Carry out Line Detection (e.g. RANSAC line detection, i.e. Random Sample and Consensus line detection):
   a. randomly select two points previously marked as substrate edges;
   b. create a line between these two points;
   c. count how many substrate edges lie on that line;
   d. If the number of these points is greater than certain threshold, add that line to a set of suspect lines; and
   e. Go back to a. for a certain number of iterations.
D2. Given the set of suspect lines, select the lines that are most likely to be correct substrate edges based on:
   a. length-the longer the detected line (the more potential edge points lie on it) the better;
   b. angle-substrate edges are likely to be either vertical or horizontal (works only if are aware of the substrate orientation on the a support, e.g. table); and
   c. angle between the pair of edges-edges of the substrate form either a right angle (vertical+horizontal) or they are parallel and at a certain distance from each other (top+bottom).

According to a preferred embodiment, the line detection steps, carried out by the image processor 10, can optionally make use of a 3D orientation (x, y, z) of the device and 2D-position (x, z) of the device determined from data of the IMUs 13a, 13b. For example, the above line selecting steps D2(a-c) can include a step d:
d. expectations from the IMU: estimation current orientation and position of the writing device (using IMU data), and predicting edge placement within the bitmap based on the estimation of the current orientation and position of the writing device.
D3. Decide on detected edges of the substrate, and calculate the tip's global position of the substrate and use this information for further processing.

It is self-evident that the invention is not limited to the above-described exemplary embodiments. Various modifications are possible within the framework of the invention as set forth in the appended claims.

For example, it will be appreciated that the processor 10 can be located in various positions within a housing of the pen 1, e.g. near the camera system or differently. The same holds for other components, such as an integrated battery (if any).

Also, for example, an afore-mentioned light emitting section and light guide structure can be configured in various ways, e.g. for emitting infrared light and/or visible light, as will be appreciated by the skilled person. As an example, one or more optical fibers can be provided to provide the at least one light emitting section (i.e. infrared light emitting section and/or visible light emitting section), and for providing the respective (infrared and/or visible light) light guide structure. Furthermore, in an embodiment, use is only made of infrared light (the pen having an infrared light source), or of visible light (the pen having a light source emitting visible light). In yet another embodiment, both infrared light and visible light can be emitted (and guided) by the pen, in case the light source is configured to generated such light e.g. in case of a light source having at least one LED emitting visible light and at least one LED emitting infrared light).

1. A handwriting detecting pen, including a writing device for performing a writing operation on a writing surface (S) of a substrate (P), wherein the writing device has a camera system for recording at least part of the writing surface (S) during operation, wherein a field of view of the camera system is at least 90 degrees, wherein the camera system has only three camera units, having mutually different viewing angles, symmetrically arranged with respect to a center line of a housing of the writing device, for recording respective sets of images that encompass the entire field of view of the camera system, wherein an optical axis (OA) of each of the three camera units encloses an angle β with a center line X of the pen, the angle β being in the range of 5 -45 degrees, wherein the writing device includes a processor configured to process images received from the camera system to determine handwriting data concerning handwriting on a recorded writing surface section, the processor being configured to evaluate and/or store detected handwriting data,
wherein the writing device includes a distal cap the cap having a central aperture for receiving a writing tip wherein the cap includes three light transmission sections, for transmitting incoming light to the three camera units of the camera system, each transmission section being associated with one of the camera units wherein the light transmission sections are wall sections, each of those light transmitting wall sections extending normally with respect to a respective camera unit's optical axis OA and being tilted with respect to a plane (Y) that is normal to the pen's center line (X).

2. The pen according to claim 1, wherein the field of view of the camera system is at least 110 degrees.

3. The pen according to claim 1, wherein the processor is configured to convert bitmap images into a vector space data, for example using an edge detection algorithm, and process the resulting vector space data to determine the handwriting data.

4. The pen according to claim 1, wherein the processor is configured to determine an orientation of the writing device with respect to the writing surface, wherein the processor is preferably configured to utilize a determined orientation of the writing device with respect to the writing surface (S) in transforming a coordinate system of determined handwriting data to a coordinate system of the writing surface (S).

5. The pen according to claim 4, including at least one inertial measuring unit (IMU), for example including a gyroscope and/or accelerometer, wherein the processor-(10) is configured to determine the orientation of the writing device with respect to the writing surface using sensor results of the at least one inertial measuring unit.

6. The pen according to claim 5, including a first inertial measuring unit at or near a proximal end of the writing device and a second inertial measuring unit at or near a distal end of the writing device.

7. The pen according to claim 1, wherein the processor is configured to process the images received from the camera system to detect at least one edge of the substrate's writing surface (S), wherein the processor is for example configured to convert bitmap images into a vector space data, preferably using an edge detection algorithm, and process the resulting vector space data to determine edge data concerning the at least one edge of the substrate's writing surface (S).

8. The pen according to claim 7, wherein the processor is configured to determine an orientation and/or a position of the writing device with respect to the writing surface using the determined edge data.

9. The pen according to claim 1, including a light source, for example a light emitting diode (LED), for illuminating at least part of the writing surface (S) with light.

10. The pen according to claim 9, wherein the cap includes at least one light emitting section for emitting illumination light of the light source, wherein the pen preferably includes a light guide structure for guiding light from the light source to each emitting section of the cap.

11. The pen according to claim 9, including a light diffuser for diffusing light emanating from the light source.

12. The pen according to claim 9, wherein the light source is configured to emit infrared light, for illuminating at least part of the writing surface (S) with infrared light.

13. The pen according to claim 9 wherein the light source is configured to emit visible light, for illuminating at least part of the writing surface (S) with visible light.

14. The pen according to claim 1, wherein the writing device has a distal writing tip and a respective ink reservoir for feeding ink to the writing tip.

15. The pen according to claim 1, wherein the pen's FOV is a substantially conical field of view, a top angle of the cone being at least 90 degrees.

16. The pen according to claim 1, wherein the cap includes radially inwardly extending wall sections providing three light entry ports leading towards the three transmission sections

17. The pen according to claim 16, wherein the radially inwardly extending wall sections of the cap extend substantially in parallel with each other and with the center line (X) of the pen, wherein proximal edges of these wall sections are located at radially inward edges of the respective light transmission sections, wherein distal edges of the radially inward wall sections are located at or near the central distal aperture of the cap.

18. The pen according to claim 1, wherein the processor is configured to process the images received from the camera system to detect at least one edge of the substrate's writing surface (S), wherein the processor is configured to convert bitmap images into a vector space data, using an edge detection algorithm, and process the resulting vector space data to determine edge data concerning the at least one edge of the substrate's writing surface (S), wherein the processor is configured to determine an orientation and/or a position of the writing device with respect to the writing surface using the determined edge data.

19. The pen according to claim 6, wherein the first inertial measuring unit and the second inertial measuring unit are spaced-apart over a distance of at least 5 cm.

20. The pen according to claim 6, wherein during operation, the integrated processor processes bitmap images received from the camera system to determine handwriting data concerning handwriting on a recorded writing surface section, wherein the processor evaluates and/or stores detected handwriting data, and converts bitmap images into vector space data, using an edge detection algorithm, and processes the resulting vector space data to determine the handwriting data, wherein the processor determines an instantaneous orientation of the writing device with respect to the writing surface (S), wherein the processor utilizes the determined orientation of the writing device with respect to the surface (S) in transforming a coordinate system of determined handwriting data to a coordinate system of the writing surface (S), wherein the actual orientation of the writing device is determined using data received from the two inertial measuring units and by detected edge data concerning the writing surface.
